(19) United States
(12) Patent Application Publication
(10) Pub. No.: US 2009/0244936 A1
(43) Pub. Date: Oct. 1, 2009

(54) Three-phase inverter

(75) Inventors: Andreas Falk, Kassel (DE); Karel De Brabandere, Kassel (DE); Frank Greizer, Kaufungen (DE); Matthias Victor, Niestetal (DE); Torben Westpahl, Kassel (DE); Henrik Wolf, Kassel (DE); Thorsten Buelo, Kassel (DE)

Correspondence Address: PYLE & PIONTEK, LLC, 221 N LASALLE STREET , ROOM 1207, CHICAGO, IL, 60601, US

(73) Assignee: SMA Solar Technology AG, Niestetal (DE)

(21) Appl. No.: 12/322,897

(22) Filed: Feb. 9, 2009

(30) Foreign Application Priority Data
Mar. 31, 2008 (EP) 08006584.0

(51) Int. Cl. H02M 7/5387; H02M 1/14

(52) U.S. Cl. 363/40; 363/132

(57) ABSTRACT

The present invention relates to a three-phase inverter (1) with a circuit arrangement having a DC-voltage input (2) for at least one direct voltage source, and a three-phase alternating voltage output (15) for feeding into a three-phase alternating voltage mains (19), wherein said inverter comprises a three-phase bridge circuit (20) as well as at least one divided intermediate circuit, wherein said inverter (1) is configured to be transformerless, wherein said neutral conductor (N) of the mains (19) is separated from the central point (M) of the intermediate circuit and the inverter (1) is connected to the alternating voltage mains (19) via a three-conductor connection (15).

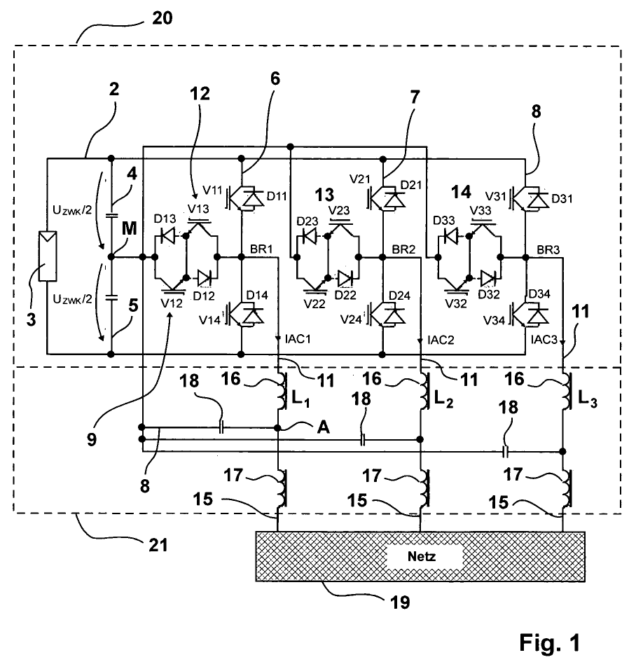

### CROSS-REFERENCE TO RELATED APPLICATIONS

This application claims Priority from European Application No. EP 08006584.0 filed on 31 Mar. 2008

1. Field of the Invention

The invention relates to a three-phase inverter with a circuit arrangement having a DC voltage input for at least one direct voltage source and a three-phase alternating voltage output for feeding into a three-phase alternating voltage mains.

Previous solutions for feeding electrical energy into a three-phase low-voltage mains via a transformerless inverter with a voltage intermediate circuit use a four-conductor connection in which all the three phases and the neutral conductor are connected with the inverter. One therefor combines three one-phase inverters of the same type into a rotary current system. With this type of interconnection, the intermediate circuit voltage for mains parallel operation must correspond to at least twice the amplitude of the conductor-neutral conductor voltage, not including a control reserve. A disadvantage thereby is the high voltage loads of the high-efficiency semiconductors as well as of the smoothing chokes, which lead to losses in efficiency.

2. Description of the Prior Art

It is known that the efficiency of the inverters may be increased using Multi-Level topologies, this being achieved by dividing the switching capacity and the thruline power on several semiconductor switches. Further, with these circuitries, load and overall size of the inductive smoothing filters on the mains side are less than with two-level topologies since the part of the fundamental component in the terminal voltage of the inverter bridge is increased by several voltage levels that may be switched discretely. For feeding into the low-voltage mains, three-level topologies constitute the most common and mostly also the most economical method.

In the document WO 2007/048420 A1 there is described a three-level inverter for feeding a photovoltaic current into a three-phase mains. This circuitry may also accommodate a high parasitic capacitance of photovoltaic generators that may lead to undesired parasitic currents. Two capacitors, which are connected with a three-phase DC-AC converter, are connected in parallel to a photovoltaic generator. At the output of the DC-AC converter, there is provided a rotary current transformer that is connected to the rotary current mains on the secondary side. A central tap at the link point of the capacitors is connected to a neutral point of the transformer on the primary side. The output of the transformer is connected to the mains through a three-conductor terminal. This solution however is not transformerless.

A transformerless inverter of the type mentioned herein above and having a Multi-Level circuit is known from DE 10 2006 010 694 A1. It describes that the voltage applying at the photovoltaic generator must at least be equal to the peak value of the conductor-neutral conductor voltage of the mains. Through the inverter circuit, the direct voltage is to be converted into an alternating voltage of a certain frequency, even if the input voltage equivalent values are insufficient, in particular below the peak value of the conductor-neutral conductor voltage of the high-efficiency mains. Switch losses as well as losses occurring when reversing the magnetic poles and ripple current of a choke are intended to be reduced. This Multi-Level circuit comprises two DC-DC boost converters so that the input voltage is increased to a higher potential. A central tap is provided on a half bridge consisting of switches. At the output of the boost converter there is respectively connected a buffer capacitor the other terminal of which is connected to the neutral conductor. The circuit arrangement moreover contains two recovery paths that extend parallel to each other between the central tap of the half bridge and the neutral conductor. Each recovery path comprises a switch with a recovery diode. This multiple interconnection however is only implemented for a one-phase connection to the low-voltage mains, though. If the system is widened to three phases, the connection is a four-conductor connection. The needed minimum voltage for parallel operation of the grid is provided by the boost converter in an additional intermediate circuit if the voltage level of the DC source drops below the minimum value. The entire intermediate circuit voltage in the range of the mains peak voltage must thereby correspond to at least twice the amplitude of the conductor—neutral conductor voltage of the mains.

### BRIEF SUMMARY OF THE INVENTION

The object of the invention is to develop an inverter of the type mentioned herein above that is suited for a three-phase low-voltage mains with the aim of achieving high efficiency.

The solution to this object is to provide a circuit arrangement incorporating three bridge branches, each having series connected switches and an active recovery branch for each bridge branch consisting of a bidirectional semiconductor switch arrangement, the inverter being connected to the low-voltage mains by a three-conductor terminal, with the central point of the intermediate circuit being separated from a neutral conductor of a three-phase low-voltage mains.

Other advantageous implementations of the invention are recited in the dependent claims.

Avoiding the prior art disadvantages, the invention provides feeding into the low-voltage mains with an intermediate circuit voltage, the amplitude level of which, more specifically not including a control reserve, corresponds to the conductor conductor voltage of the mains. High efficiency is thus achieved. The circuit topology corresponds to a Multi-Level circuit with an actively switched recovery branch consisting of a bidirectional semiconductor switch.

The idea underlying the invention is not to connect the central point of the intermediate circuit with a neutral conductor of the mains and to utilize a three-conductor terminal instead of a four-conductor terminal.

Through the circuit of the invention, only the smallest possible intermediate circuit voltage is needed for the transformerless mains parallel operation.

The losses within the inverter are less than with a four-conductor system.

High-frequency potential jumps at the DC source and, as a result thereof, parasitic capacitive currents at the generator are avoided as a matter of principle.

Additionally, high voltage loads of the power semiconductors as well as of the smoothing chokes, which lead to losses in efficiency, are avoided.

In an advantageous developed implementation of the inverter of the invention, there is provided that a mains filter is connected between the AC-output and a mains input of the three-phase low-voltage mains, said mains filter incorporating for each bridge branch two series-connected chokes and one capacitor connected between the chokes, each capacitor being only connected to the central point of the intermediate circuit so that the neutral conductor of the mains is separated from the central point of the intermediate circuit. Thanks to this measure, it is readily possible to realize a sinusoidal signal on the one side and to thereby separate the central point of the intermediate circuit from the neutral conductor of the three-phase low-voltage mains without a transformer being needed.

Using the divided intermediate circuit, which is formed from two series-connected capacitors which are connected to the filter capacitors at their link point, it is possible to only utilize one single generator. The generator voltage divides into the more specifically identical capacitor so that three voltage levels are provided. As a result, a three-level circuit is possible.

An advantage is obtained if the bidirectional semiconductor circuit arrangement incorporates two switches connected in opposite directions of polarity, each having antiparallel diodes. Through these active recovery paths, high efficiency is possible with a rotary current system.

Practically, an intermediate circuit voltage not including a control reserve corresponds exactly to the amplitude of the conductor-conductor voltage of the three-phase mains. The control reserve more specifically ranges from about 0 to 15%, and is in particular about 10% of the conductor-conductor voltage. If the effective value of the conductor-conductor voltage is 400 V, the intermediate circuit voltage or the generator voltage is 585V=(400V×\sqrt{2})+20V if the control reserve is e.g., 20 V.

In principle, the Multi-Level circuit may have more than three voltage levels. It is particularly economical though if the Multi-Level circuit arrangement is configured to be a three-level circuit. Only two buffer capacitors and one or two generators are needed. Additional boost converters, which cause additional losses, are not necessary.

In principle, DC sources such as fuel cells, batteries or other direct voltage generators may be connected to the inverter. In another preferred implementation of the invention, there is provided that at least one photovoltaic generator may be connected to the DC voltage input of the inverter. Typical high-frequency potential jumps at the photovoltaic generator due to the pulsing of the switches are avoided. A pulse-width method or any other pulsing method needed by this pulsing may then be utilized

The invention will be explained in closer detail herein after with reference to the drawing.

### BRIEF DESCRIPTION OF THE DRAWING

The FIGURE shows a circuit diagram of a preferred embodiment of a circuit arrangement of the invention in an inverter.

### DETAILED DESCRIPTION OF THE INVENTION

The inverter 1 shown incorporates a Multi-Level circuit arrangement with a DC-voltage input 2 for at least one direct voltage source, in particular for a photovoltaic generator 3. Several photovoltaic generators may however also be connected in series and/or in parallel.

There is provided a divided intermediate circuit that is formed from two buffer capacitors 4, 5. There is further provided a bridge branch 6 with two series-connected switch elements V11, V14 and with one active recovery path 9. The inverter has an AC output 15 for feeding into a low-voltage mains 19. The inverter 1 is configured to be transformerless.

The generator 3 supplies the intermediate circuit voltage Uzwk, which is halved in each buffer capacitor 4, 5. Accordingly, three voltage levels, e.g., 0V, 300V and 600 V, may be measured at the capacitor branch. The circuit arrangement is configured to be a three-level circuit.

In accordance with the invention, the circuit arrangement incorporates three bridge branches 6, 7, 8, each having series-connected switches V11, V14 und V21, V24 and V31, V34, respectively. Each bridge branch 6, 7, 8 has an active recovery branch 12, 13, 14 consisting of an active bidirectional semiconductor switch array.

In accordance with the invention, the inverter 1 is connected to the low-voltage mains N by a three-conductor terminal as illustrated in the FIGURE, a central point M of the intermediate circuit being separated from a neutral conductor of the three-phase low-voltage mains N. The three conductors correspond to the phases L1, L2, L3.

Each switch V11, V14 and V21, V24 and V31, V34 is provided with an antiparallel recovery diode D11, D14 and D21, D24 and D31, D34.

The FIGURE further shows that between the AC output 11 and a mains input 15 of the three-phase low-voltage mains N there is connected a mains filter. Said mains filter incorporates six chokes and three capacitors, namely two series connected chokes 16, 17 and one capacitor 18 connected between the chokes 16, 17 for each bridge branch 6, 7, 8. Each capacitor 18 is only connected with the central point M of the intermediate circuit. The neutral conductor of the mains N is thus separated from the central point M of the intermediate circuit. Accordingly, the filter capacitor 18 is connected at its one end with the link point A of the chokes 16, 17 and at its other end or point B with the central point M. The divided intermediate circuit is formed by the two capacitors 4, 5 which are connected to the filter capacitors 18 at their link point B. Thanks to the filter the output voltage at the AC output is smoothed and becomes sinusoidal.

As also illustrated in the FIGURE, the bidirectional semiconductor switch array incorporates two switches V12, V13 or V22, V23 or V32, V33 connected in opposite directions of polarity, each of the switch having antiparallel diodes D12, D13 or D22, D23 or D32, D33. The switches V12, V13 or V22, V23 or V32, V33 are controlled actively so that high-frequency voltages are avoided. Switch losses as well as magnetic reversal losses and ripple currents of the chokes 16, 17 are also reduced thereby.

The frequency of the mains may be 50 Hz or 60 Hz. The intermediate circuit voltage Uzwk is slightly higher than the peak value of the conductor-conductor voltage of e.g., 565 V. Preferably, the intermediate voltage circuit Uzwk, which does not include a control reserve of the peak value, exactly corresponds to the conductor-conductor voltage of e.g., 565 V of the three-phase mains 19. The control reserve may e.g., be 20 Volt so that a mains separation is avoided as a rule.

The generator 3 has a capacitance against ground. Thanks to the circuit shown, parasitic capacitive ground leakage currents of a photovoltaic generator 3 are reduced.

The circuit arrangement shown allows to feed into the low-voltage mains N without transformer starting from an intermediate circuit voltage Uzwk the height of which, not including a control reserve, corresponds exactly to the amplitude of the conductor-conductor voltage of the mains N of e.g., 565 V. As opposed to four-conductor systems in which the neutral conductor of the mains N is rigidly connected to the central point M of the intermediate circuit, the minimum intermediate circuit voltage needed in the circuit under discussion is reduced by factor 0.866.

Using suited modulation methods such as e.g., a space vector modulation or a modulation with the superimposed third harmonics or other modulation methods, the efficiency is improved.

The separation of the central point M of the intermediate circuit from the neutral conductor of the mains N thereby prevents currents from propagating in the mains, which would otherwise be excited by the zero phase sequence system. The resulting driving voltage for the mains currents thus no longer contains a zero phase sequence system and has a maximum amplitude that is greater than the intermediate circuit voltage by factor 1,155 (=1/0,866).

In order to avoid undesirable high-frequency leakage currents from the DC generators, the circuit arrangement shown does not generate any high-frequency potential jumps and only negligible low-frequency potential changes the frequency of which typically corresponds to three times the mains frequency and the amplitude of which typically corresponds at most to 13.4% of the mains voltage amplitude.

The invention is not only limited to this exemplary embodiment. Boost converters or other DC-DC stages may be connected in order to provide for additional levels or potentials.

Also, each single feature that has been described or shown may be combined with any one of the other features.

### LIST OF NUMERALS

1 Inverter
2 DC-voltage input
3 photovoltaic generator
4, 5 buffer capacitors
6, 7, 8 bridge branches
9 recovery path
10 -
11 AC-output
12, 13, 14 recovery branches
15 mains input
16, 17 chokes
18 filter capacitor
19 low-voltage mains
20 bridge circuit
21 mains filter
N neutral conductor
M central point of the intermediate circuit
A link point of the chokes

We claim:

1. A three-phase inverter (1) with a circuit arrangement having a DC-voltage input (2) for at least one direct voltage source and a three-phase alternating voltage output (15) for feeding into a three-phase alternating voltage mains (19), wherein said inverter comprises a three-phase bridge circuit (20) as well as at least one divided intermediate circuit, wherein said inverter (1) is configured to be transformerless, wherein said neutral conductor (N) of the mains (19) is separated from the central point (M) of the intermediate circuit and the inverter (1) is connected to the alternating voltage mains (19) via a three-conductor connection (15).

2. The three-phase inverter as set forth in claim 1, characterized in that the mains filter incorporates at each output of the bridge circuit at least one storage choke as well as at least one capacitor, each capacitor being connected with only the central point (M) of the intermediate circuit so that the neutral conductor (N) of the mains (19) is separated from the central point (M) of the intermediate circuit.

3. The three-phase inverter as set forth in claim 1, characterized in that the divided intermediate circuit is formed by two series-connected capacitors (4, 5) that are connected with the filter capacitors (18) at their link point (A).

4. The three-phase inverter as set forth in claim 1, characterized in that the circuit arrangement is configured to be a Multi-Level circuit arrangement.

5. The three-phase inverter as set forth in claim 4, characterized in that the Multi-Level circuit arrangement is configured to be a three-level circuit.

6. The three-phase inverter as set forth in claim 5, characterized in that the three-level circuit arrangement incorporates three bridge branches, each having series-connected switches and one active recovery branch for each bridge branch, consisting of a bidirectional semiconductor arrangement.

7. The three-phase inverter as set forth in claim 6, characterized in that the bidirectional semiconductor arrangement incorporates two switches (V12, V13 or V22, V23 or V32, V33 resp.) connected in opposite directions of polarity, each having antiparallel diodes (D12, D13 or D22, D23 or D32, D33 resp.).

8. The three-phase inverter as set forth in claim 1, characterized in that an intermediate circuit voltage not including a control reserve corresponds to the amplitude of the conductor-conductor voltage of the three-phase mains (19).

9. The three-phase inverter as set forth in claim 1, characterized by an implementation such that at least one photovoltaic generator (3) may be connected to the DC voltage input (2).

10. The three-phase inverter as set forth in claim 1, characterized in that the bridge circuit is activated such that the voltage between the central point of the intermediate circuit and the neutral conductor of the mains only consists of components of the zero phase sequence system.

11. The three-phase inverter as set forth in claim 1, characterized in that the inverter (1) incorporates a mains filter (21).
